(19) United States
(12) Patent Application Publication
(10) Pub. No.: US 2004/0128180 A1
(43) Pub. Date: Jul. 1, 2004

(54) Integrating logistic and financial control of projects

(76) Inventors: Claus-Dieter Abel, Heidelberg (DE); Monika Ahrens, Heidelberg (DE); Volker Faisst, Ilvesheim (DE); Martin Hertel-Szabadi, Heidelberg (DE); Thorsten Schneider, Walldorf (DE); Manfred Stindl, Wiesloch (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/331,154

(22) Filed: Dec. 27, 2002

(51) Int. Cl. G06F 17/60

(52) U.S. Cl. 705/9

(57) ABSTRACT

Methods and apparatus, including computer program products, for controlling projects. A logistic structure and a financial structure are specified for a project. The logistic structure includes multiple logistic objects representing activities related to the project, and the financial structure includes cost collectors representing financial responsibilities related to the project. The financial structure is independent of the logistic structure. A responsibility mapping is defined to associate each activity represented in the logistic structure with a cost collector that is responsible for financial aspects of the activity. The responsibility mapping is independent of the logistic structure representing the activities.

### BACKGROUND

The present invention relates to data processing by a digital computer.

A successful project, e.g., to develop a product or to organize a trade fair, requires precise planning of many detailed activities and corresponding resources. Typically, the project is divided into logistic and financial sides. On the logistic side, a technical project manager is responsible for planning activities for the project and, later, controlling that they are executed efficiently and on time. The technical project manager can use computer applications called project controllers, such as cProjects available from SAP AG, Waldorf, Germany, to organize the project. For example, the project can be structured into tasks, i.e., groups of activities with corresponding goals, deadlines, and/or responsibilities. From the tasks, a hierarchical logistic structure can be built by collecting related tasks into work packages or phases, or by splitting a large task into smaller tasks.

On the financial side, a business project manager prepares financial plans for the project, and later ensures that the project is executed according to the planned budget, and funds are available when needed. Furthermore, the business project manager collects and reports financial information about the project to accounting using different financial ledgers. A financial ledger is a framework for organizing and presenting data with financial impact. For example, a financial ledger can correspond to a particular area of accounting, reporting, or evaluation, or to a cost or profit center of a company.

To control financing of the project, the project controller builds a structure of financial objects, typically, by associating each task with a financial object called a “cost collector.” For each task, the associated cost collector collects financial information, e.g., costs or revenues, related to logistic transactions corresponding to the task. Examples of logistic transactions include purchases or confirmations of work done by an employee for the task. Due to the one-to-one correspondence between tasks and cost collectors, the financial structure typically matches the logistic structure and a common data structure can be, and typically is, used for both logistic and financial data.

### SUMMARY OF THE INVENTION

The present invention provides methods and apparatus, including computer program products, for integrating logistic and financial control of projects represented by different logistic and financial structures. In general, in one aspect, the invention features methods and apparatus, including computer program products that implement techniques for controlling projects. The techniques include specifying logistic and financial structures and defining a responsibility mapping. The logistic structure includes multiple logistic objects, where each logistic object represents one or more activities related to a project. The financial structure includes one or more cost collectors, where each cost collector represents financial responsibility related to the project. The financial structure is independent of the logistic structure. The responsibility mapping associates each activity represented in the logistic structure with a cost collector that is responsible for financial aspects of the activity. The responsibility mapping is independent of the logistic structure representing the activities.

In general, in another aspect, the invention features methods and apparatus, including computer program products that implement techniques for controlling projects. The techniques include identifying a project characterized by a logistic structure, a financial structure and a responsibility mapping. The logistic structure includes a plurality of logistic objects representing activities related to the project. The financial structure includes one or more cost collectors representing financial responsibility related to the project. The responsibility mapping associates each activity represented in the logistic structure with a cost collector that is responsible for financial aspects of the activity. The logistic structure is changed and a cost collector is automatically identified in the financial structure. The identified cost collector is associated with activities in the changed logistic structure according to the responsibility mapping without changing the financial structure.

In general, in another aspect, the invention features methods and apparatus, including computer program products that implement techniques for controlling projects. The techniques include identifying a project characterized by a logistic structure, a financial structure and a responsibility mapping. The logistic structure includes a plurality of logistic objects representing activities related to the project. The financial structure includes one or more cost collectors representing financial responsibility related to the project. The responsibility mapping associates each activity represented in the logistic structure with a cost collector that is responsible for financial aspects of the activity. The financial structure is changed without changing the logistic structure. The responsibility mapping is modified to associate each activity represented in the logistic structure with a cost collector in the changed financial structure.

Particular implementations can include one or more of the following features. The responsibility mapping can be defined based on: a process attribute corresponding to one or more activities represented in the logistic structure; or an identification of a person performing an activity represented in the logistic structure. A cost collector can be automatically identified for each activity represented in the logistic structure. The identified cost collector can be associated with the activity according to the responsibility mapping. A first cost collector can be automatically identified as being responsible for a first activity according to the responsibility mapping. The first activity can be represented by a first logistic object in the logistic structure. The first cost collector can be automatically identified as being responsible for a second activity according to the responsibility mapping. The second activity can be represented by a second logistic object in the logistic structure. Multiple candidate cost collectors can be automatically identified, where candidate cost collectors are candidates for being responsible for a given activity according to the responsibility mapping. A cost collector can be selected among the candidate cost collectors as being responsible for the given activity based on a predefined criterion.

The logistic structure can be changed without changing the financial structure. The financial structure can be changed without changing the logistic structure. The responsibility mapping can be modified to associate each activity represented in the logistic structure with a cost collector in the changed financial structure. Logistic data from the logistic structure and financial data from the financial structure can be used to control execution of the project. A hierarchical structure can be specified for the financial or the logistic structure.

The invention can be implemented to realize one or more of the following advantages. A project controller can represent and efficiently control a project having different structures for logistic objects, e.g., tasks, and financial objects, e.g., cost collectors. For example, a cost collector can be automatically identified for a logistic transaction, such as a work confirmation or purchasing. Users of the logistic structure do not have to know about the financial structure. A cost collector can be identified based on attributes of the logistic transaction, e.g., based on employee identification in a work confirmation. A task can be associated with multiple cost collectors representing, e.g., different companies or profit centers, without splitting the task to match the financial structure. The financial structure can be reorganized without changing the logistic structure of the tasks, and vice versa. For example, a task can be split into smaller tasks without creating corresponding cost collectors. Logistic data can be accessed independently from financial data, and vice versa. Allowing independent data access can create a clear distinction between responsibilities for financial and logistic organizations of a project. For example, access to financial data can be limited to the business manager only. Financial data can be stored in an optimal size data structure that is independent of the logistic structure, e.g., when a detailed logistic structure is represented by a simple financial structure. By optimizing the size of financial data, job control performance can be improved. The project controller can include job costing tools. The project controller can include a general project ledger for posting project related financial data to different general financial ledgers, and one or more special project ledgers that include special characteristics of the project. For example the special project ledger can include project related key figures, e.g., progress rates. General financial ledgers, e.g., costs, revenues, and down payments, can be combined to provide additional functions, e.g., economic viability analysis.

The details of one or more implementations of the invention are set forth in the accompanying drawings and the description below. Further features, aspects, and advantages of the invention will become apparent from the description, the drawings, and the claims.

### BRIEF DESCRIPTION OF THE DRAWINGS

FIG. 1 is a schematic diagram showing a project controller.

FIG. 2 is a schematic diagram showing job costing tools.

FIGS. 3A, 3B, 4, 5A, and 5B are schematic flow diagrams showing methods for organizing projects.

Like reference numbers and designations in the various drawings indicate like elements.

### DETAILED DESCRIPTION

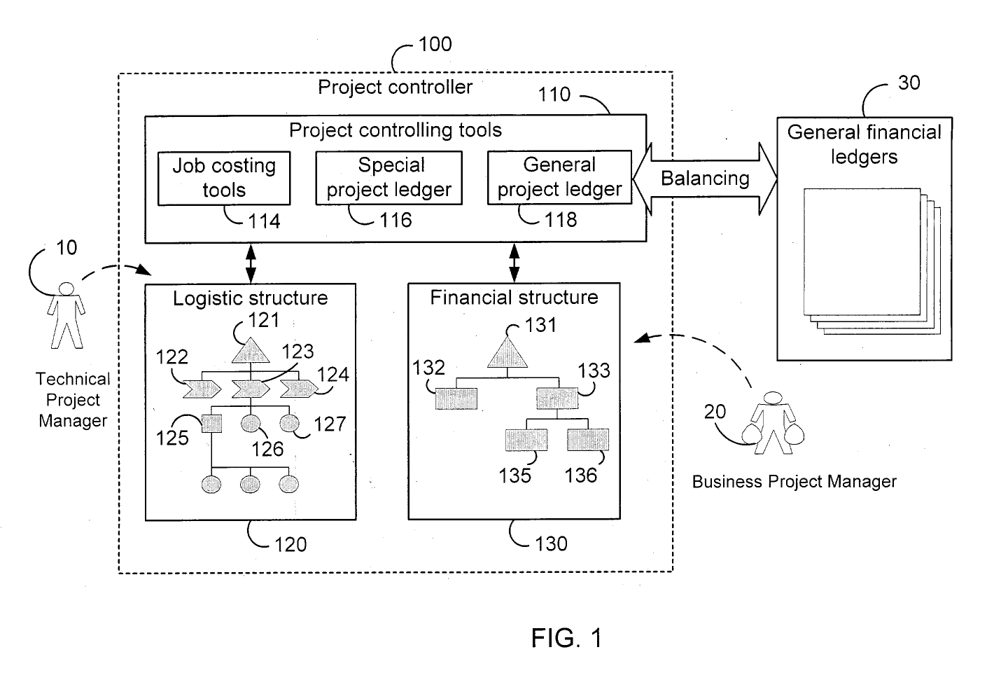

As shown in FIG. 1, a project controller 100 can be used to plan and control a project. The project controller 100 includes project controlling tools 110 and one or more logistic 120 and financial 130 structures associated with one or more projects. The project controlling tools 110 can be used to control a project, and to synchronize the logistic 120 and financial 130 structures by allowing data flow between the two structures. The logistic 120 and financial 130 structures can be used, e.g., by a technical project manager 10 and a business project manager 20, respectively, to plan and execute a project. The technical and business managers are not required to use the same or similar structure and are allowed to change the corresponding structure without notifying each other.

The project controller 100 exchanges financial data with general financial ledgers 30 outside the project. The general financial ledgers 30 can include, e.g., ledgers representing accounting, cost centers, or profit centers in one or more companies. The project controller 100 can report, i.e., post, financial data to one or more of the general financial ledgers 30, and can receive balancing information related to the project from any of the general financial ledgers 30.

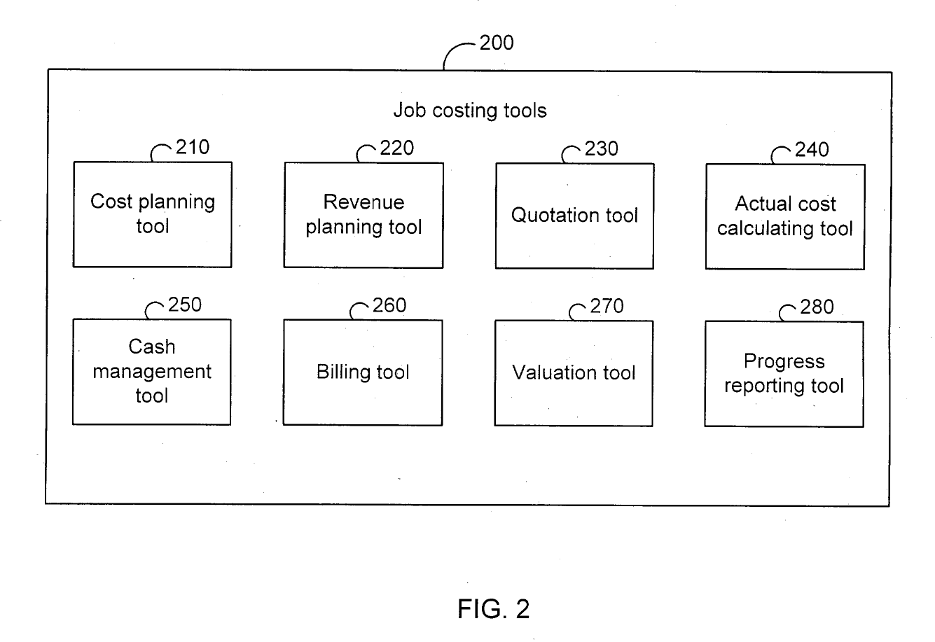

The project controlling tools 110 include job costing tools 114, a special project ledger 116, and a general project ledger 1.18. The job costing tools 114 can provide “job control”, i.e., financial control of the logistic structure 120. In a colloquial sense, job control answers the question “How much does a project or an element in the project cost?”, and in the case of customer oriented jobs, “What are the revenue and the profit?”. Typically, the job costing tools 114 use data and post corresponding results in the special 116 and general 118 project ledgers. Alternatively, the job costing tools can use ledgers that are not related to the project. Optionally, the job costing tools can access the logistic and financial structures as well. The job costing tools are discussed in detail with reference to FIG. 2.

The special project ledger 116 can be defined to provide data for financial functions that are characteristic to a given project. For example, the special project ledger 116 can be defined by its own accounting principles, such as period pattern, or currency; can have its own chart of accounts; can include progress rate of the project, or other process characteristics; and, can offer special functions, such as economic viability analysis. The special project ledger 116 can be updated, e.g., by financial data from the financial structure 130. The special project ledger 116 can be updated according to its own period, synchronously with the accounting interface, or when data is requested by project functions, such as progress analysis. Optionally, the project controlling tools 110 can include more than one special project ledger, each designed for a specific function.

The general project ledger 118 can be used to exchange, e.g., post or balance, financial information with any of the financial ledgers 30 that represent accounting, cost, or profit centers of companies related to the project. The general project ledger 118 has the same financial parameters (e.g., chart of accounts or currencies) as the general financial ledgers 30. In one implementation, all financial posting is passed to the financial ledgers 30 through the general project ledger 118 from the project controller 100.

The logistic structure 120 specifies activities and corresponding goals and resources for executing a project. In the logistic structure 120, the entire project is represented by a project head 121. The project head 121 includes one or more identifiers that can be used to identify logistic elements in the logistic structure 120. For example, the project head 121 can include a project identifier identifying the project and pointers identifying phases of the project. The project identifier can also be used to identify the financial structure 130 corresponding to the same project. In one implementation, the project head 121 also specifies activities for the technical project manager 10.

The logistic structure can include a hierarchy of multiple logistic objects. For example, the project can be divided into phases, such as phases 122-124. Each phase describes a temporal stage of the project. For example, a project to build a house can include the following phases: building a base, a first floor, a second floor, and a roof. Starting a next phase may require completion of one or more previous phases of the project. For each phase, the logistic structure 120 can identify a responsible person, e.g., the technical project manager 10 can be responsible for planning and executing all phases 122-124. Alternatively, different persons can be responsible for different phases.

Each phase can include tasks, such as the phase 123 includes tasks 125, 126 and 127. Optionally, as shown in FIG. 1 for task 125, each task can be divided into smaller tasks. A task specifies activities and corresponding resources. For example, the task can specify the type and amount of products required to successfully execute the activities of the task. Each task can specify roles, such as number, time, and qualification of persons required to perform the activities specified in the task. The task can also include goals, such as deadlines or budget goals for the specified activities. The task can identify persons or company units responsible for executing or financing all or some of the roles or activities.

The financial structure 130 can include one or more financial objects, e.g., cost collectors. Each cost collector represents an area of responsibility for money spending, and typically corresponds to a person. For example, the business project manager 20 can correspond to a head collector 131 that represents the entire project on the financial side. The head collector 131, similar to the project head 121 on the financial side, includes one or more identifiers to identify the project and other cost collectors in the financial structure 130. In one implementation, some activities for the business project manager are also specified by the head collector 131.

In one implementation, each cost collector corresponds to a financial unit that is involved in the project. In the example shown in FIG. 1, cost collectors 132 and 133 correspond to a first and a second company, respectively, that participate in the project. Furthermore, the second company has a first and second departments with corresponding cost collectors 135 and 136, respectively. In alternative implementations, different cost collectors can be implemented for different type of activities during the project. For example, separate cost collectors can be responsible for purchasing, transporting, or selling.

Each object in the logistic structure 120 can include activities that are associated with one or more cost collectors in the financial structure 130. For example, activities in the first phase 122 can be associated with both the first 132 and second 133 cost collectors corresponding to the first and second companies, respectively. Financial responsibilities can be shared between the first 132 and the second 133 cost collectors by specifying activities for which each of the two companies is responsible. For example, the first cost collector 132 can be responsible for purchases and the second cost collector 133 for personnel, i.e., roles, during the first phase 122 of the project. In one implementation, a different process attribute is specified for the different activities, and the specified process attributes are used to automatically find the responsible cost collector for a logistic transaction.

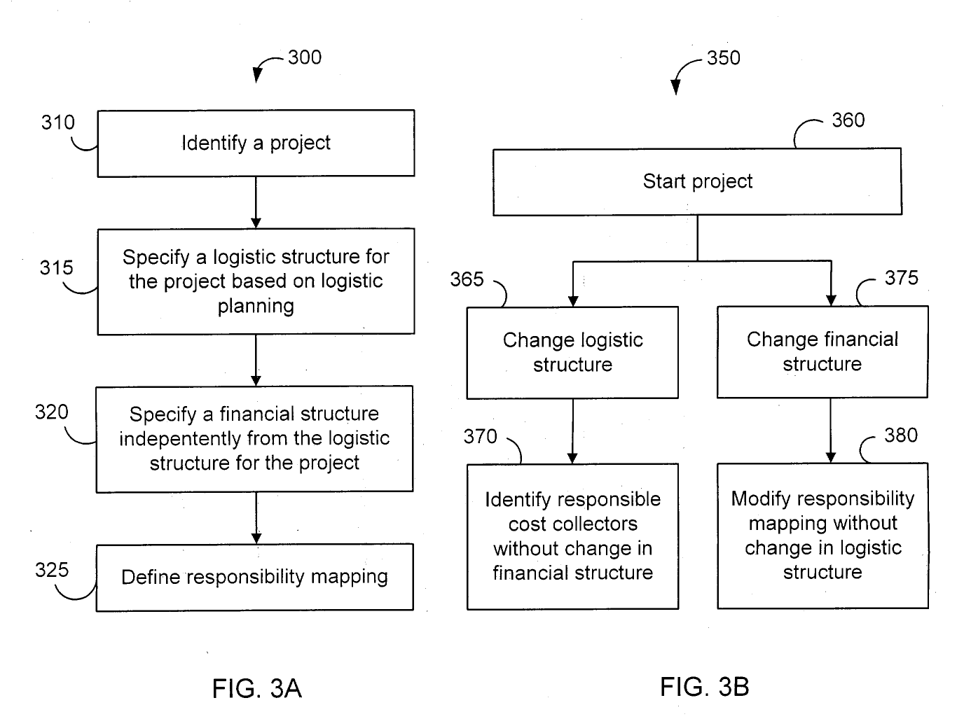

Alternatively or in addition, a single cost collector can be responsible for activities in more than one phase or task. For example, the first cost collector 132 can be responsible for purchases in all phases and tasks of the logistic structure 120. Responsibilities for cost collectors can be established and altered at any stage of executing a project as discussed with reference to FIGS. 3A and 3B.

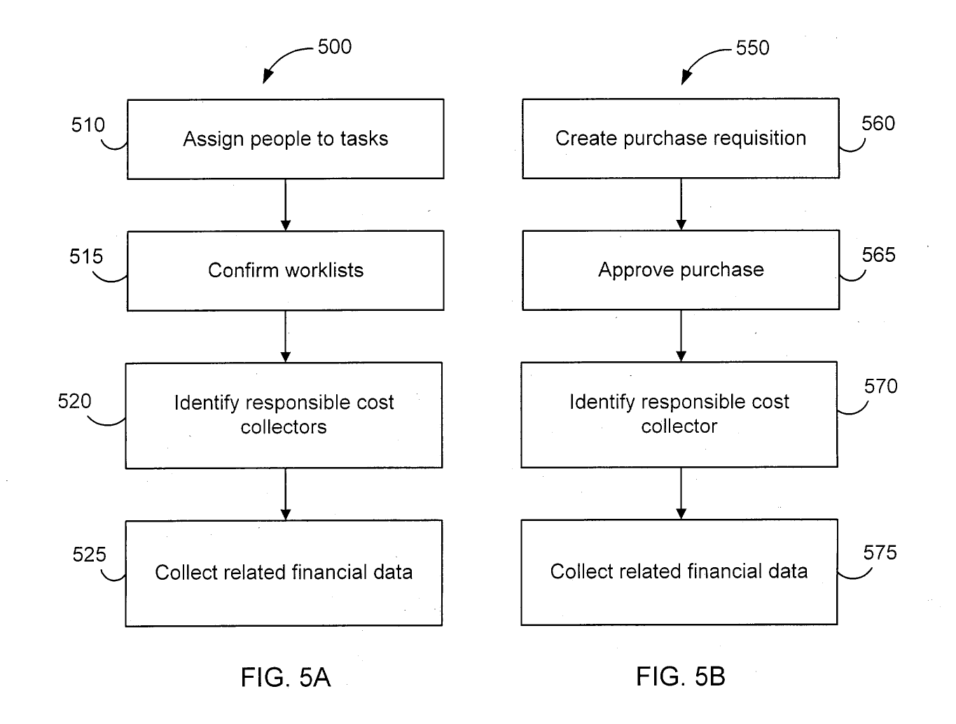

In the financial structure 130, the head collector 131 and other cost collectors can automatically collect financial data related to logistic transactions during the project. For example, cost collectors can automatically receive work confirmations or purchase related data, e.g., by using methods that are discussed with reference to FIGS. 5A and 5B. The cost collectors can provide and update financial data for the job costing tools 114 or the project ledgers 116 and 118. In the financial structures 130, different cost collectors can have different authority for accessing financial data collected by other cost collectors. Each cost collector can have specific valuation methods or different legal requirements.

FIG. 2 shows job costing tools 200 that can be included in the project controlling tools 110 (FIG. 1). The job costing tools 200 typically use data in, and post results to, project ledgers such as the project ledgers 116 and 118 in FIG. 1. The job costing tools 200 can use the logistic structures 120 and the financial structures 130 as well, e.g., to perform a detailed analysis of the project. To plan, evaluate, and control a project, the job costing tools 200 include a cost planning tool 210, a revenue planning tool 220, a quotation tool 230, an actual cost calculating tool 240, a cash management tool 250, a billing tool 260, a valuation tool 270, and a progress reporting tool 280. In alternative implementations, the job costing tools 200 can include fewer, different, or additional tools. For example, some tools can be combined into a single tool, or a single tool can be split into multiple tools.

The cost planning tool 210 can be used both for automatic costing or manual cost planning. The cost planning tool 210 can estimate an early cost, and plan a time-dependent cost for the project or phases or tasks of the project. The cost estimate can be based on logistic planning, e.g., on the logistic structure 120 (FIG. 1). The revenue planning tool 220 and the quotation tool 230 can be used for sales pricing and generating a quotation (optionally, in combination with the cost planning tool 210). The revenue planning 220 and quotation 230 tools are typically used for projects that produce a product or service for sale to a customer. The revenue 220 and quotation 230 tools can use both logistic data (e.g., required resources) and financial data (e.g., cost estimate) in the project ledgers. Revenues can be planned or updated periodically.

The actual cost calculating tool 240 keeps track of costs and revenues during the project. Actual costs are posted by both logistic transactions, e.g., work confirmations or purchases, and financial transactions, e.g., invoices. The cash management tool 250 is used to monitor all incoming and outgoing payments, and to calculate internal interests based on the payments. The billing tool 260 is typically used for resource related billing. The billing tool 260 can use logistic and/or financial data. The valuation tool 270 determines cost of sales, sales revenues, and work in process for a project. Basis for valuation can include planned and actual costs and revenues, and also project progress or resource related billing. The progress reporting tool 280 can provide controlling data for a reporting environment. The progress reporting tool 280 can be used for project controlling from the business management's perspective (financial side) or for progress analysis (logistic side).

As shown in FIGS. 3A and 3B, logistic and financial structures can be generated or altered independently from each other at any stage of a project without loosing clear financial responsibility for logistic and financial control of the project. In the implementations shown in FIGS. 3A and 3B, financial responsibility is established by using a responsibility mapping.

FIG. 3A shows a method 300 for creating logistic and financial structures for a project. The method 300 can be performed, e.g., by using the project controller 100 (FIG. 1). A project is identified (step 310), e.g., by using a project identifier. For the identified project, a logistic structure is specified based on logistic planning (step 315). The logistic structure can be specified based exclusively on logistic information, such as activities required by the project and available resources for the activities. The specified logistic structure can be independent from any financial structural information, such as number of different companies or departments having financial responsibilities in the project. For example, a single task in the logistic structure can include a first activity for which a first company is responsible, and a second activity for which a second company is responsible. However, the single task does not have to be split to match the responsibilities of the first and second companies.

A financial structure is specified for the project independently from the logistic structure (step 320). The financial structure can be based exclusively on financial structural information, and being independent of any logistic information. For example, the financial structure can include a cost collector for each participating company independently of how a technical project manager structures activities for which the companies are responsible.

A responsibility mapping is defined (step 325) to establish which cost collector in the financial structure is responsible for an activity in the project. The responsibility mapping associates each activity represented in the logistic structure with a cost collector that is responsible for the financial aspects of the activity. The responsibility mapping establishes responsibility without explicitly specifying tasks or phases for which a cost collector is responsible. Instead, only the head collector in the financial structure is associated with the project head in the logistic structure to identify the corresponding project. For example, both the head collector and the project head can use the same project identifier.

In addition to the project identifier, attributes of logistic transactions can be used to establish responsibilities for cost collectors. In one implementation, the responsibility mapping specifies a company code for a cost collector representing the corresponding company. By using the company code and a project identifier of the project, the cost collector can automatically collect costs related to work confirmations or purchases for which the company is responsible in the project. Alternatively or in addition, the responsibility mapping can specify a process attribute for a cost collector. The process attribute can be used to automatically identify logistic transactions for which the cost collector is responsible. Identifying cost collectors is further discussed with reference to FIGS. 5A and 5B.

Optionally, the responsibility mapping can establish financial responsibility by explicitly associating a cost collector in the financial structure with one or more logistic objects in the logistic structure. For example, a special identifier, similar to the project identifier, can be specified for the corresponding cost collector and the associated logistic objects. The special identifier in combination with optional process attributes can be used to identify a responsible cost collector for activities in the associated logistic objects.

FIG. 3B shows a method 350 for changing the logistic structure independently from the financial structure, and vice versa, during execution of a project. The method 350 can be performed by using, e.g., the project controller 100 (FIG. 1) that specifies a logistic structure, a financial structure, and a responsibility mapping for the project as discussed with reference to FIG. 3A. After starting (step 360), the project proceeds independently in the logistic and financial sides. In the logistic side, the logistic structure is changed (step 365). The logistic structure can be changed without notifying the financial side or changing the financial structure according to the change in the logistic structure. For example, the logistic structure can be changed by splitting up a “parent” task into multiple “child” tasks.

Responsible cost collectors are identified for activities in the changed logistic structure without change in the financial structure (step 370). If the responsibility mapping has not been changed, the same cost collector is identified for each activity before and after the change in the logistic structure. Alternatively, if desired, the responsibility mapping can be altered, e.g., by changing process attributes for some activities in the logistic structure, and the changed process attributes may specify different cost collectors.

In the financial side, the financial structure is changed without notifying the logistic side (step 375). For example as shown in FIG. 1, a cost collector can be split up: the second company 133 can delegate project related purchasing responsibilities to the first department 135 and payroll responsibilities to the second department 136 without notifying the logistic side.

The responsibility mapping is modified without changing the logistic structure (step 380). The modification can establish financial responsibility for cost collectors in the changed financial structure. Financial responsibility can be established without changing the logistic structure by using the techniques discussed above with reference to FIG. 3A.

If any time during the execution of the project, financial responsibility is not uniquely established, the project controller may not be able to automatically find a single responsible cost collector for some activities in the project. However, the project controller can identify one or more candidates for a responsible cost collector. For example, if no responsible cost collector has been found, the candidate can be the head collector. If more than one cost collectors can be responsible for an activity, the project controller can request user input, e.g., from the business project manager, to select one of the candidates.

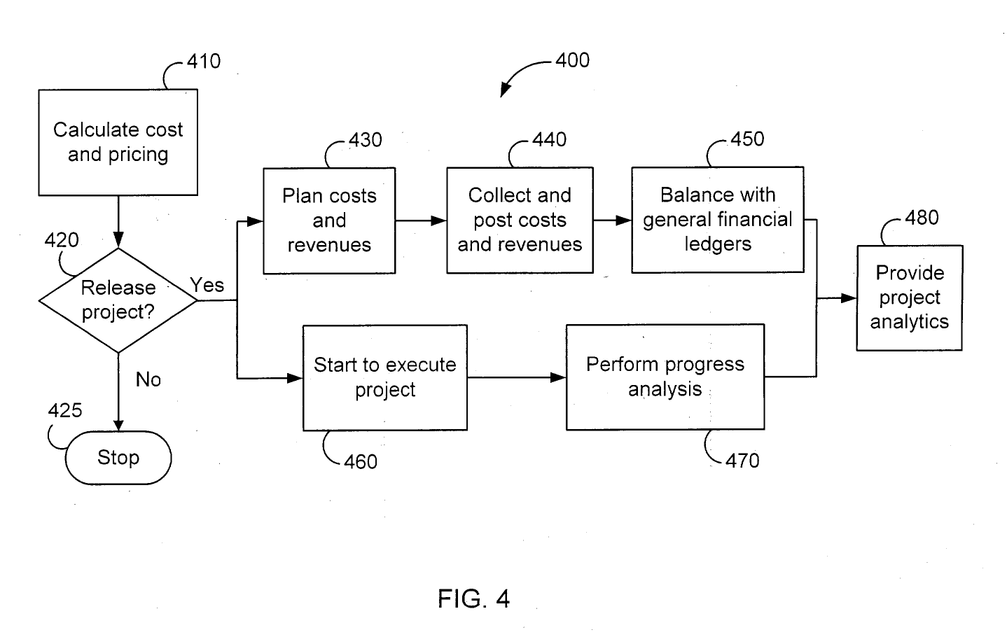

FIG. 4 shows a method 400 for planning and controlling a project. The method 400 can be performed, for example, by using the project controller 100 (FIG. 1). The method 400 starts during an initial planning of a project by calculating costs and/or prices related to the project (step 410). The cost estimate can be based on logistic planning that includes generating a logistic structure for the project. The logistic structure can be used, for example, by the cost planning tool 210 (FIG. 2) to calculate the total cost estimate. For customer projects, the total cost (or the estimate) can be a basis for a sales price or a quotation.

Based on the cost estimate, a decision 420 is made to release the project. The decision 420 can be made according to a customer's choice, i.e., the costumer can accept or refuse the quotation, or by management of the companies that are involved in the project. If the decision 420 is negative (“No” branch), the project stops (step 425). If the decision 420 is positive (“Yes” branch), the project starts on both the logistic and financial sides. The project controller provides automatic information exchange that allows to proceed with the project independently on the financial and logistic sides.

In the logistic side, the execution of the project can be started (step 460) based on the logistic structure used for calculating costs and pricing. Alternatively, further logistic planning can alter the logistic structure before starting execution of the project. As discussed above with reference to FIGS. 3A and 3B, if necessary, the logistic plan and the corresponding logistic structure can be altered without notifying the financial side during the execution of the project. For example, progress of the project can be analyzed (step 470) with the progress reporting tools 280 (FIG. 2). Based on the results of the analysis, corrections can be made in the logistic structure without notifying the financial side.

In the financial side, costs and revenues are planned for the project as a function of time (step 430), for example, by the cost 210 and revenue 220 planning tools (FIG. 2). In one implementation, cost estimates are calculated for each logistic task. Optionally, a discrete cost planning (i.e., cost forecast) can be obtained manually or automatically. By using cost collectors organized in a financial structure corresponding to the project, actual costs and revenues are collected automatically and posted to project ledgers, such as the special 116 and general 118 project ledgers (step 440). In one implementation, the cost collectors pass all project related values to the project ledgers, and the general project ledger 118 balances with the general financial ledgers 30 (step 450).

Data resulting from the balancing can be combined to provide a complex project analytics (step 480) at the end of the project. Optionally, a project analytics can be performed if the business project manager notices financial anomalies, e.g., overspending, during the project. Typically, the project analytics requires collaboration between the financial and logistic sides.

FIGS. 5A and 5B show exemplary methods 500 and 550 for confirming worklists and purchases, respectively, by cost collectors according to one implementation of the invention. The methods can be performed, e.g., by using the project controller 100 (FIG. 1).

As shown in FIG. 5A, the method 500 can be used for collecting financial data related to a worklist. People of different units are assigned to one or more tasks of the project (step 510). For example, each of the assigned people receives a worklist specifying activities of the corresponding task. The assigned people need only to know the logistic object, i.e., the task, to which they are assigned, and knowing a corresponding cost collector is not required.

Next, a responsible person on the logistic side (e.g., the technical project manager) confirms the worklists (step 515). For each confirmed worklist, the project controller automatically identifies a responsible cost collector (step 520). The responsible cost collector can be identified, for example, based on the assigned persons identification, a corresponding company code, and/or a specified process attribute, as discussed above with reference to FIGS. 3A and 3B. Alternatively, the cost collector can be identified based on the task only. If the project controller cannot identify a responsible cost collector, a list of candidate cost collectors can be provided to the business manager. The business manager can assign a cost collector manually, e.g., by selecting one of the candidate cost collectors or creating a new cost collector. Once a responsible cost collector has been identified, the identified cost collector collects financial data related to the confirmed worklist (step 525).

As shown in FIG. 5B, the method 550 can be used for approving purchases. A purchase requisition is created (step 560) and the purchase is approved by a responsible person (step 565). The project controller identifies a responsible cost collector for the purchase (step 570). As discussed above with reference to FIGS. 3A, 3B, and 5A, the project controller may identify the responsible cost collector, e.g., based on a project attribute or a logistic object, e.g., a task in the logistic structure 120, corresponding to the purchase. If there is no corresponding logistic object, for example, a computer is purchased for the entire project, the project controller can identify the head collector as the responsible cost collector. The identified cost collector collects the financial data related to the purchase (step 575).

The invention can be implemented in digital electronic circuitry, or in computer hardware, firmware, software, or in combinations of them. The invention can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

The invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments. Other embodiments are within the scope of the following claims. For example, the steps of the invention can be performed in a different order and still achieve desirable results.

What is claimed is:

1. A computer program product, tangibly embodied in an information carrier, for controlling projects, the computer program product including instructions operable to cause data processing apparatus to:
specify a logistic structure including a plurality of logistic objects, each logistic object representing one or more activities related to a project;
specify a financial structure including one or more cost collectors, each cost collector representing financial responsibility related to the project, the financial structure being independent of the logistic structure; and
define a responsibility mapping associating each activity represented in the logistic structure with a cost collector that is responsible for financial aspects of the activity, the responsibility mapping being independent of the logistic structure representing the activities.

2. The computer program product of claim 1, wherein the instructions operable to cause data processing apparatus to define a responsibility mapping include instructions operable to cause data processing apparatus to:
define a responsibility mapping based on a process attribute corresponding to one or more activities represented in the logistic structure.

3. The computer program product of claim 1, wherein the instructions operable to cause data processing apparatus to define a responsibility mapping include instructions operable to cause data processing apparatus to:
define a responsibility mapping based on an identification of a person performing an activity represented in the logistic structure.

4. The computer program product of claim 1, further comprising instructions operable to cause data processing apparatus to:
for each activity represented in the logistic structure, automatically identify a cost collector associated with the activity according to the responsibility mapping.

5. The computer program product of claim 4, wherein the instructions operable to cause data processing apparatus to automatically identify a cost collector for each activity represented in the logistic structure include instructions operable to cause data processing apparatus to:
automatically identify a first cost collector as being responsible for a first activity according to the responsibility mapping, the first activity being represented by a first logistic object in the logistic structure; and
automatically identify the first cost collector as being responsible for a second activity according to the responsibility mapping, the second activity being represented by a second logistic object in the logistic structure.

6. The computer program product of claim 4, wherein the instructions operable to cause data processing apparatus to automatically identify a cost collector include instructions operable to cause data processing apparatus to:
automatically identify a plurality of candidate cost collectors that are candidates for being responsible for a given activity according to the responsibility mapping; and
select a cost collector among the plurality of candidate cost collectors as being responsible for the given activity based on a predefined criterion.

7. The computer program product of claim 1, further comprising instructions operable to cause data processing apparatus to:
change the logistic structure without changing the financial structure.

8. The computer program product of claim 1, further comprising instructions operable to cause data processing apparatus to:
change the financial structure without changing the logistic structure.

9. The computer program product of claim 8, further comprising instructions operable to cause data processing apparatus to:
modify the responsibility mapping to associate each activity represented in the logistic structure with a cost collector in the changed financial structure.

10. The computer program product of claim 1, further comprising instructions operable to cause data processing apparatus to:
use logistic data from the logistic structure and financial data from the financial structure to control execution of the project.

11. The computer program product of claim 1, wherein the instructions operable to cause data processing apparatus to specify a financial structure include instructions operable to cause data processing apparatus to:
specify a hierarchical structure for the financial structure including a plurality of cost collectors.

12. The computer program product of claim 1, wherein the instructions operable to cause data processing apparatus to specify a logistic structure include instructions operable to cause data processing apparatus to:
specify a hierarchical structure for the logistic structure.

13. A computer program product, tangibly embodied in an information carrier, for controlling projects, the computer program product including instructions operable to cause data processing apparatus to:
identify a project characterized by a logistic structure, a financial structure and a responsibility mapping, the logistic structure including a plurality of logistic objects representing activities related to the project, the financial structure including one or more cost collectors representing financial responsibility related to the project, and the responsibility mapping associating each activity represented in the logistic structure with a cost collector that is responsible for financial aspects of the activity;
change the logistic structure; and
automatically identify a cost collector in the financial structure, the identified cost collector being associated with activities in the changed logistic structure according to the responsibility mapping without changing the financial structure.

14. The computer program product of claim 13, wherein the instructions operable to cause data processing apparatus to identify a project characterized by a responsibility mapping include instructions operable to cause data processing apparatus to:
identify a project characterized by a responsibility mapping based on a process attribute corresponding to one or more activities represented in the logistic structure.

15. The computer program product of claim 13, wherein the instructions operable to cause data processing apparatus to identify a project characterized by a responsibility mapping include instructions operable to cause data processing apparatus to:
identify a project characterized by a responsibility mapping based on an identification of a person performing an activity represented in the logistic structure.

16. The computer program product of claim 13, further comprising instructions operable to cause data processing apparatus to:
use logistic data from the logistic structure and financial data from the financial structure to control execution of the project.

17. A computer program product, tangibly embodied in an information carrier, for controlling projects, the computer program product including instructions operable to cause data processing apparatus to:
identify a project characterized by a logistic structure, a financial structure and a responsibility mapping, the logistic structure including a plurality of logistic objects representing activities related to the project, the financial structure including one or more cost collectors representing financial responsibility related to the project, and the responsibility mapping associating each activity represented in the logistic structure with a cost collector that is responsible for financial aspects of the activity;
change the financial structure without changing the logistic structure; and
modify the responsibility mapping to associate each activity represented in the logistic structure with a cost collector in the changed financial structure.

18. The computer program product of claim 17, wherein the instructions operable to cause data processing apparatus to identify a project characterized by a responsibility mapping include instructions operable to cause data processing apparatus to:
identify a project characterized by a responsibility mapping based on a process attribute corresponding to one or more activities represented in the logistic structure.

19. The computer program product of claim 17, wherein the instructions operable to cause data processing apparatus to identify a project characterized by a responsibility mapping include instructions operable to cause data processing apparatus to:
identify a project characterized by a responsibility mapping based on an identification of a person performing an activity represented in the logistic structure.

20. The computer program product of claim 17, further comprising instructions operable to cause data processing apparatus to:
use logistic data from the logistic structure and financial data from the financial structure to control execution of the project.

21. A method for controlling projects, the method comprising:
specifying a logistic structure including a plurality of logistic objects, each logistic object representing one or more activities related to a project;
specifying a financial structure including one or more cost collectors, each cost collector representing financial responsibility related to the project, the financial structure being independent of the logistic structure; and
defining a responsibility mapping associating each activity represented in the logistic structure with a cost collector that is responsible for financial aspects of the activity, the responsibility mapping being independent of the logistic structure representing the activities.

22. The method of claim 21, wherein defining a responsibility mapping comprises:
defining a responsibility mapping based on a process attribute corresponding to one or more activities represented in the logistic structure.

23. The method of claim 21, wherein defining a responsibility mapping comprises:
defining a responsibility mapping based on an identification of a person performing an activity represented in the logistic structure.

24. The method of claim 21, further comprising:
for each activity represented in the logistic structure, automatically identifying a cost collector associated with the activity according to the responsibility mapping.

25. The method of claim 24, wherein automatically identifying a cost collector for each activity represented in the logistic structure comprises:
automatically identifying a first cost collector as being responsible for a first activity according to the responsibility mapping, the first activity being represented by a first logistic object in the logistic structure; and
automatically identifying the first cost collector as being responsible for a second activity according to the responsibility mapping, the second activity being represented by a second logistic object in the logistic structure.

26. The method of claim 24, wherein automatically identifying a cost collector for each activity represented in the logistic structure comprises:
automatically identifying a plurality of candidate cost collectors that are candidates for being responsible for a given activity according to the responsibility mapping; and
select a cost collector among the plurality of candidate cost collectors as being responsible for the given activity based on a predefined criterion.

27. The method of claim 21, further comprising:
changing the logistic structure without changing the financial structure.

28. The method of claim 21, further comprising:
changing the financial structure without changing the logistic structure.

29. The method of claim 28, further comprising:
modifying the responsibility mapping to associate each activity represented in the logistic structure with a cost collector in the changed financial structure.

30. The method of claim 21, further comprising:
using logistic data from the logistic structure and financial data from the financial structure to control execution of the project.

31. The method of claim 21, wherein specifying a financial structure comprises:
specifying a hierarchical structure for the financial structure including a plurality of cost collectors.

32. The method of claim 21, wherein specifying a financial structure comprises:
specifying a hierarchical structure for the logistic structure.

33. A method for controlling projects, the method comprising:
identifying a project characterized by a logistic structure, a financial structure and a responsibility mapping, the logistic structure including a plurality of logistic objects representing activities related to the project, the financial structure including one or more cost collectors representing financial responsibility related to the project, and the responsibility mapping associating each activity represented in the logistic structure with a cost collector that is responsible for financial aspects of the activity;
changing the logistic structure; and
automatically identifying a cost collector in the financial structure, the identified cost collector being associated with activities in the changed logistic structure according to the responsibility mapping without changing the financial structure.

34. The method of claim 33, wherein identifying a project characterized by a responsibility mapping comprises:
identifying a project characterized by a responsibility mapping based on a process attribute corresponding to one or more activities represented in the logistic structure.

35. The method of claim 33, wherein identifying a project characterized by a responsibility mapping comprises:
identifying a project characterized by a responsibility mapping based on an identification of a person performing an activity represented in the logistic structure.

36. The method of claim 33, further comprising:
using logistic data from the logistic structure and financial data from the financial structure to control execution of the project.

37. A method for controlling projects, the method comprising:
identifying a project characterized by a logistic structure, a financial structure and a responsibility mapping, the logistic structure including a plurality of logistic objects representing activities related to the project, the financial structure including one or more cost collectors representing financial responsibility related to the project, and the responsibility mapping associating each activity represented in the logistic structure with a cost collector that is responsible for financial aspects of the activity;
changing the financial structure without changing the logistic structure; and
modifying the responsibility mapping to associate each activity represented in the logistic structure with a cost collector in the changed financial structure.

38. The method of claim 37, wherein identifying a project characterized by a responsibility mapping comprises:
identifying a project characterized by a responsibility mapping based on a process attribute corresponding to one or more activities represented in the logistic structure.

39. The method of claim 37, wherein identifying a project characterized by a responsibility mapping comprises:
identifying a project characterized by a responsibility mapping based on an identification of a person performing an activity represented in the logistic structure.

40. The method of claim 37, further comprising:
using logistic data from the logistic structure and financial data from the financial structure to control execution of the project.
